(19) United States
(12) Patent Application Publication
(10) Pub. No.: US 2007/0188535 A1
(43) Pub. Date: Aug. 16, 2007

(54) Method for printing on clear or translucent substrates

(76) Inventors: Hamdy A. Elwakil, Hockessin, DE (US); Eric Pray, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/706,465

(22) Filed: Feb. 13, 2007

Related U.S. Application Data
(60) Provisional application No. 60/773,291, filed on Feb. 14, 2006.

(51) Int. Cl. B41J 2/205

(52) U.S. Cl. 347/15

(57) ABSTRACT

A method is described for printing on translucent substrates, such as thermoplastic polymer materials, which method utilizes a white ink as a process ink to achieve selective opacity and enhanced color effects derived from the white ink. The white ink jetting and the colored ink jetting are printed essentially simultaneously.

### CROSS-REFERENCE TO RELATED APPLICATION

This application claims priority under 35 U.S.C. §119 from U.S. Provisional Application Ser. No. 60/773,291, filed Feb. 14, 2006.

### BACKGROUND OF THE INVENTION

1. Field of the Invention

This present invention pertains to a method of printing white ink onto a clear or translucent substrate, such as a translucent thermoplastic polymer material. The invention also pertains to a method of inkjet printing with an ink set including a white ink and at least one other colored ink.

2. Description of the Related Art

Inkjet printing is a non-impact printing process in which droplets of ink are deposited on print media, such as paper or polymeric substrates, to form the desired image. The droplets are ejected from a printhead in response to electrical signals generated by a microprocessor.

Colored inkjet inks comprise one or more colorants that are dissolved (e.g., dyes) and/or dispersed (e.g., pigments and dispersed dyes) in the ink vehicle. The ink vehicle can be aqueous (significant amounts of water) or non-aqueous (predominantly organic liquid), and the ink is referred to as aqueous or non-aqueous ink accordingly.

Inkjet printing has been described for printing on many substrates including paper, textiles, transparencies, thermoplastic polymer substrates, etc. Effective white inks have been sought for enhancements to ink jet printing, especially for non-white substrates.

There are many publications describing various aspects of using a white ink in ink jet printing. For example, U.S. Pat. No. 4,630,076 describes a color ink jet system with an additional white ink that is printed on top of the previously printed color dots.

US2001/0020964 describes the use of a quick drying white ink printed over another ink or adjacently. This use of white ink is particularly directed to use of the white ink with a black ink.

U.S. Pat. No. 5,439,514 describes an aqueous ink which has both a colorant and a white inorganic material in the same ink.

U.S. Pat. No. 6,769,766 describes the need for a white UV ink for ink jet printers.

WO02/096654 provides a possible solution to the problem of the settling of a titanium dioxide (white) pigment in an ink, by agitating an ink cartridge by having a continuous ink-flow subsystem to inhibit settling of solids out of suspension.

U.S. Pat. No. 6,989,054 describes an inorganic phosphoric acid treated titanium dioxide that can be slurried to obtain an aqueous ink.

U.S. Pat. No. 6,433,038 describes an aqueous photocurable ink that has anatase titanium dioxide as the colorant.

US2004/0246319, EP-A-1321497, EP-A-1388578 and WO00/049097 all describe inks that contain a polymerizable compound and a white pigment and/or titanium dioxide.

U.S. Pat. No. 4,680,580 describes a white ink with an inorganic white pigment, a binder resin, a solvent selected from an alcohol, ketone, ether or acetate ester and cyclohexanone, which are solvents for the binder, and a conductive salt. This ink is primarily effective for continuous ink jet printers.

WO04/053002 discloses an opaque ink jet ink which has similar features to the ink disclosed in U.S. Pat. No. 4,680,580, as it is an ink with a conductive component and suggested for utility with continuous ink jet printers.

US2005/0264632 describes a use of a white layer which is printed prior to the image being printed, to serve as an undercoat for an ink jet process.

US2005/0146544 a polymerizable white ink which is printed before or after the image is printed.

None of these cited publications provide the methodology needed for printing on clear or translucent materials such that the image can be viewed from both sides (with the backside appearing as the inverted image).

A common utility for printed translucent substrate, such as a thermoplastic polymer material, is as one of the layers of a multi-layer laminate. For example, safety glass for automobiles and architectural glass laminates can contain a thermoplastic polymeric material as a thin film layer in the glass laminate structure.

Any transmissive/translucent color image may be viewed under a variety of different viewing conditions. If an image is applied onto a transparent or highly translucent surface, the visual appearance is highly dependent on the lighting behind the image. For example, if the area behind the image is very dark, the colors tend to become very muted (very low chroma and very low Lightness (L*)). However, if these same images are viewed with white behind them, the colors tend to be much higher in chroma (more saturated) and lighter. If this same image is then viewed with a very intense light source behind it, the colors tend to wash out (very high L*, but low chroma). Accordingly, the drawback is that at all viewing angles, the image cannot be clearly seen.

To solve this problem in applications such as an image placed in an automotive windshield for viewing from outside the car, a white layer has sometimes been placed behind the image on the glass, and/or the laminate “sandwich” has included some form of white backing. These backings can be, but are not limited to:
a “soft white” backing layer (allowing 80% light transmission PVB medium) behind the image to provide slightly more reflectance;
a “trans white” backing layer (allowing 67% light transmission PVB medium) behind the image to provide more reflectance; or
a white ceramic frit printed on the glass after lamination (with no backing layer) to simulate the effect of placing a white surround behind the image.

With this white layer behind the image, the appearance from behind the image (e.g., inside the vehicle) is one of just a white layer with perhaps a suggestion of an image.

Thus, there is a need for improved methods of printing for clear or translucent materials such as translucent thermoplastic plastic materials, which permits the viewing of the same white-containing image from both sides of a printed transparent surface.

### SUMMARY OF THE INVENTION

With ordinary CMYK (cyan, magenta, yellow and black) and other colors, images can be achieved, but since the printed image should be viewed from both sides, there is a need for a white ink that can be used as a “process color” (defined below) to achieve a wider range of images and viewability from both sides of the laminate. In addition, the ability to use a white ink to complement other inks of an ink set can lead to improved images, especially when lighter tones and/or higher degrees of coverage or selective opacity are needed.

The present invention is directed to printing an image on a clear or translucent substrate, such as a thermoplastic polymer material, which image has white features in it and can be viewed from both of the sides of the image, without respect the direction of the lighting.

With the present invention, the printing of the white ink with the colors (as a process ink) achieves a better overall result, with the colors in the image being more saturated and lighter, but not washed out.

The present invention thus replaces the need for a solid white layer behind the image by printing the white ink and the colored inks substantially at the same time.

In one aspect of the present invention, there is provided a method for inkjet printing an image onto a clear or translucent substrate, comprising the steps of:

(1) providing an inkjet printer, preferably drop-on-demand, that is responsive to digital data signals;

(2) loading the printer with a clear or translucent substrate to be printed;

(3) loading the printer with an inkjet ink set comprising a white ink and at least one other colored ink; and

(4) printing onto the substrate using the inkjet ink set in response to the digital data signals to generate the image,

wherein the image has a margin so as to include the at least one other colored ink and the white ink in said image, and wherein the at least one colored ink is not printed onto the substrate outside the margins of the image, and wherein the at least one colored ink and the white ink are printed substantially at the same time.

The present invention also provides for printing on clear or translucent substrates, such as thermoplastic polymer materials, with the above-mentioned method set such that the white ink can be deposited to selectively obtain new coloring effects and selectively control the opacity on the printed substrate.

This present invention further provides for the imaged clear or translucent substrate produced by this printing method.

This present invention still further provides for a laminate product produced from the so-produced imaged clear or translucent substrate.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Unless otherwise stated, the following terms have the meaning as set forth below in the context of the present invention.

A “process color” is a primary color component that may be used by itself, or in conjunction with one or more other primary color components, to produce a desired color in a given area of an image.

A “spot color” is a color that is used by itself, never in conjunction with other process colors. A spot color might be utilized in an area of the image where no other color is present. An example of a spot color would be the red color used to help distinguish Coca Cola®.

In accordance with the present invention, the inkjet printer utilized prints the white and the other colored inks “substantially at the same time”. What this means is that the substrate only passes once through the printer (in simplex mode) to generate the complete image. This is to be distinguished from the situation, for example, when a portion of the image is printed, then the substrate is re-fed through the printer to finish the image or print another portion of the image, often printing a colored image on top of a white underprint.

For clarification, “single pass” in reference to the substrate is different than “single pass” in reference to the operation of a printhead. Ink jet printers commonly use a scanning printhead. After the printhead is scanned across the substrate, the page is incrementally advanced in a direction orthogonal to the scanning axis to position the substrate for a subsequent scan. The printed image is thus composed of a contiguous series of horizontal swaths, which taken together, create the overall image. Each swath is typically the height of the array of nozzles on the printhead. Thus, in the context of a printhead, one scan of the printhead across the substrate per incremental advance is referred to as “single pass”, and multiple scans across the substrate per incremental advance is referred to as “multi pass”.

In the context of the present invention, the jetting of the white ink and the colored inks onto the substrate can be controlled in any fashion in order to obtain the desired dot pattern. For example, a white ink dot could be printed below, adjacent or over a colored dot, but this variation is not a critical part of the invention. The control of the printing of the inks is obtained from the computer/digital system that controls the printer.

By using the inventive method of printing white ink, the reflection of the image can be controlled by the amount of white ink in various parts of the image. By printing white with colors, the probability is that light will be reflected back into the observer's eyes. The white ink can be printed on parts of the image that have no other colored inks, or where white is required for the image.

Any inkjet compatible white ink can be utilized in the instant invention. From a general effectiveness standpoint stable, ink jet inks are preferred. Examples of the preferred white inks include the aqueous white ink described in commonly owned U.S. patent application Ser. No. 10/872,856 (filed Jun. 21, 2004), and a non-aqueous white ink described in Ser. No. 11/070,714 (filed Mar. 2, 2005) (the disclosures of which are incorporated by reference herein in their entirety for all purposes as if fully set forth).

A specific preferred example of an aqueous white ink comprises an aqueous vehicle having dispersed therein:

(a) a titanium dioxide pigment; and

(b) a combination of dispersants comprising:
(1) a graft copolymer having a weight average molecular weight of from about 4,000 to about 100,000, comprising from about 90% to about 50% by weight of a polymeric backbone, and from about 10% to about 50% by weight of macromonomer side chains attached to the backbone, the polymeric backbone and macromonomer side chains comprising 100 wt % of the graft copolymer, wherein:
   (i) the polymeric backbone is hydrophobic in comparison to the macromonomer side chains and comprises one or more polymerized ethylenically unsaturated hydrophobic monomers and, optionally, up to about 20% by weight, based on the weight of the graft copolymer, of polymerized ethylenically unsaturated acid monomers; and
   (ii) each of the macromonomer side chains individually is a hydrophilic polymer containing acids groups attached to the polymeric backbone at a single terminal point, and
      (A) has a weight average molecular weight of from about 1,000 to about 30,000, and
      (B) comprises from about 2% to about 100% by weight, based on the weight of the macromonomer side chain, of a polymerized ethylenically unsaturated acid monomer, and
      (C) wherein the acid groups are at least partially neutralized, preferably with an inorganic base and/or an amine; and
(2) a block copolymer of type AB, ABA or ABC wherein at least one of the blocks in the block copolymer is an adsorbing segment, and wherein at least one of the blocks in the block copolymer is a stabilizing segment.

An optional third dispersant can be used and is a phosphated polymer dispersant comprising a hydrophilic stabilizing segment and a hydrophobic adsorbing segment.

A specific preferred example of a non-aqueous white inkjet ink comprises a non-aqueous liquid carrier having dispersed therein (a) a titanium dioxide pigment and (b) at least one dispersant for the titanium dioxide pigment, wherein:

(i) the non-aqueous liquid carrier comprises an organic solvent or a mixture of organic solvents,

(ii) the organic solvent or mixture of organic solvents has a hydrogen bonding solubility parameter based on Hansen solubility parameters of more than about 9,

(iii) the organic solvent or mixture of organic solvents in non-aqueous liquid carrier comprises are predominantly only non-reactive organic solvents; and

(iv) the conductivity of the ink is from about 1 to about 50 μmho/cm.

### Alternatively, the white pigment ink dispersion can have the limitation that the solvent mixture has a mixture boiling point of greater than 120° C. at 0.1 kpascals.

The instant invention utilizes the white ink as a process color not a spot color. As a process color the white ink will be printed essentially simultaneously (substantially at the same time) with the other process colors. The ink jet printer will control the white ink and print it as if it were a process color like the normal ink jet colors cyan, magenta, yellow and black.

The white ink can also be used as a spot color in the areas outside the margins of the image for emphasis and contrast.

The ink sets used for this instant invention contain the white ink described above and a at least one other colored ink, preferably a plurality of other colored inks. The non-white inks of the ink set contain other colorants. There is no particular limit as to the non-white inks used in this invention, except that they need to be compatible with the white ink.

A particularly useful CMYK ink set is described in US20040187732 (the disclosure of which is incorporated by reference herein for all purposes as if fully set forth). In this ink set the yellow ink is a yellow ink comprising PY120 dispersed in a non-aqueous vehicle; the magenta is a magenta ink comprising a complex of PV19 and PR202 dispersed in a non-aqueous vehicle; the cyan ink is a cyan ink comprising PB 15:3 and/or PB 15:4 dispersed in a non-aqueous vehicle and the black is a pigmented black ink.

The white ink can be obtained by using white pigments such as aluminum oxide, zinc oxide, titanium dioxide. Titanium dioxide is the preferred pigment.

Titanium dioxide (TiO₂) pigment useful in the present invention may be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the relevant disclosure of which is incorporated by reference herein for all purposes as if fully set forth.

The titanium dioxide particles can have a wide variety of average particle sizes of about 1 micron or less, depending on the desired end use application of the ink.

The titanium dioxide pigment is in and of itself white in color.

For applications demanding high hiding or decorative printing applications, the titanium dioxide particles preferably have an average size of less than about 1 micron (1000 nanometers). Preferably, the particles have an average size of from about 50 to about 950 nanometers, more preferably from about 75 to about 750 nanometers, and still more preferably from about 100 to about 500 nanometers. These titanium dioxide particles are commonly called pigmentary TiO₂.

For applications demanding white color with some degree of transparency, the pigment preference is “nano” titanium dioxide. “Nano” titanium dioxide particles typically have an average size ranging from about 10 to about 200 nanometers, preferably from about 20 to about 150 nanometers, and more preferably from about 35 to about 75 nanometers. An ink comprising nano titanium dioxide can provide improved chroma and transparency, while still retaining good resistance to light fade and appropriate hue angle.

In addition, unique advantages may be realized with multiple particle sizes, such as opaqueness and UV protection. These multiple sizes can be achieved by using both a pigmentary and a nano grade of TiO₂ of this invention.

The titanium dioxide may be stabilized sufficiently for printing in an ink jet printer. Previously cited references provide the means for stabilizing the titanium dioxide.

The method of this invention provides for improved colored images on thermoplastic polymer substrate medium. The ability to use a white ink provides a variety of improved color means. This inventive methodology will provide gamut expansion under certain printed and viewing conditions. With dark background conditions and colors measured in reflectance mode there is an apparent gamut improvement. With a light background the gamut appears to contract.

The importance of the viewing perspective to understand the import of the invention can best be illustrate by discussion of how this inventive method is used to achieve a viewable image in an automobile (e.g., car or truck) windshield, or another glass laminate. The thermoplastic polymeric substrate medium after it is printed is laminated with other layers such as glass so that the final product has the image within the laminate structure. These laminate structures are called a decorative laminate.

During the daylight when a windshield is viewed from the outside of the car looking in, the viewer is viewing any images on or in the windows of the car in reflection mode. During the daylight, there is a large amount of ambient light entering the car from the outside (due to sun's illumination), passing through the glass windows into the car, then reflecting/refracting/absorbing in the car's interior. The light that is reflected will pass back through the image in the glass and into the viewer's eye. A dark car interior means that there is no “extra” or increase in the probability that the light reflects/refracts in the correct angles to reemerge out of the vehicle, especially through the image. The resultant color is mostly resulting from the reflection of the light off of the incident surface of the windshield (the front surface) with no added (or very little) component of returning light from inside the vehicle.

When the image is printed by the instant invention the image has the requisite reflectance derived from the white ink in the image to reflect the image back to the viewer. From inside the vehicle the driver/passenger can also see the image, all be it in its inverted format. The white ink used as a process color and simultaneously printed within the image provides the requisite reflection for the image to be seen from both direction. Although this illustration was for an automobile windshield, it equally applies to other uses of the printed thermoplastic polymeric substrate. Currently when images are sought for windshields and the like, a white background is applied behind the image, like soft white, trans white and the white ceramic frit described previously. Although the image can be seen from outside the car under a daylight condition the driver/passenger can only see the white background and not the image.

The instant invention provides a means to print images that have not been able to be printed before. If a person using digital ink printing technology is asked to print an image with significant amount of white and off-white areas on a clear or translucent material, they cannot. Inherently the ink set and printed system provided to him presumes that the white will provided by the (white) paper substrate. With the instant invention, the availability of a controllable white process ink significantly increases the. person's printing options. An example of this would be the desire to have a white flower among other colored flowers and green foliage imaged onto a laminate such that the white flower image could become part of architectural glass. With the white ink methodology described herein, this white flower can be faithfully imaged on to a thermoplastic polymer substrate as a first step in making an imaged laminate.

The inkjet printer responsive to digital signals can be any inkjet printer that produces images. Typical inkjet printers are controlled by a computer that has various drivers and other software that control the printing of the ink. The white ink is contained in one of the ink cartridges loaded in to the printer, and various scanning/color interpretation methodologies are applied to utilize the white ink. In one example, the white ink can be used in the ‘black’ cartridge to obtain the printing patterns for testing. A more likely use of the white ink will be as a separate, additional ink cartridge that is controlled by the printer software.

### Printed Substrates

The instant invention is particularly advantageous for printing on thermoplastic polymeric (non-porous) substrates such as polyvinyl butyral interlayer (including 15 and 30 mil thickness); spun bonded polyolefin (e.g.Tyvek®, DuPont); polyvinyl chloride; polyethylene terephthalate polyester; polyvinyl fluoride polymer, and the like.

A particularly preferred use for the ink sets of the present invention is the decorative printing of polyvinyl butyral interlayers used in safety or architectural glass applications, such as disclosed in commonly owned WO2004018197, the disclosure of which is incorporated by reference herein for all purposes as if fully set forth.

### Printing Tests

Any common inkjet printer can be used to test the present inventive method. Unless otherwise noted, the examples described below were done using an Epson 3000 ink jet printer or a Mimaki JV3 wide format printer, and prints were made on various substrates. One means of printing used white ink in place of the black ink and images were produced using Adobe PhotoShop software. The substrates included polymeric sheets such as: polyvinyl butyral interlayer (15, 30 ml thickness); Tyvek® JetSmart (DuPont); uncoated polyvinyl chloride; Tedlar® (DuPont); polyethylene terephthalate; and Surlyn® (DuPont). In addition, textiles and paper were also used as substrates. Polyurethane was obtained from Deerfield Urethane, South Deerfield, Mass.

### EXAMPLES

Various abbreviations used in these Examples are listed below in Table 1. All printing tests were done with polyvinyl butyral interlayer substrates.

TABLE I
List of Abbreviations

| | |
|---|---|
| DPM | Dipropylene glycol methyl ether |
| DPMA | Dipropylene glycol methyl ether acetate |
| TPnP | Tripropylene glycol propyl ether |
| DPnP | Dipropylene glycol propyl ether |
| TPM | Tripropylene glycol methyl ether |
| PNP | Propylene glycol n-propyl ether |
| cps | Centipoise |
| nBA | n-butyl acrylate |
| MA | Methyl acrylate |
| AA | Acrylic acid |
| MAA | Methacrylic acid |
| MMA | Methyl methacrylate |
| BMA | n-Butyl methacrylate |

### Slurry/Dispersion Ex. 1

Slurry Ex 1 was prepared as a 100 gram batch by charging the ingredients listed in Table 2 into a plastic jar (250 ml capacity) and following these steps:

(1) In a 250 ml plastic bottle, the solvents (s) as well as the dispersants were added.

(2) The mixture was mixed until the dispersants dissolved completely in the solvents.

(3) The white pigment was added slowly to the container

(4) The contents were mixed well, then the zirconium media (0.8-1.0 mil zirconium media) was added.

(5) The plastic container was then added to a roller mill, the speed of which was adjusted to 35 rpm.

TABLE 2
Slurry Ex 1, Composition

| Slurry Ex. 1 | |
|---|---|
| Disperbyk ® 2000 | 8.71 |
| Dispersant 1/2B (50/50 wt %) | 5.17 |
| PnP | 361.12 |
| Ti-Pure R700 | 250.00 |
| Total | 625.00 |

Disperbyk ® 2000 was obtained from Byk Chemie, Wesel Germany.

Dispersant 1 was a graft polymer with a comb-like structure, with a molecular configuration of:

nBA/MA/M (45.5/45.5/9)//g-MMA/MM (71.25/28.75)

The polymer backbone (nBA/MA/M) made up 69% of the polymer. The notation (45.5/45.5/9) indicates the relative weight percentages of each monomer, that is, 45.5 wt % n-butyl acrylate, 45.5 wt % methyl acrylate, and 9 wt % acrylic acid. The arms, which were the macromonomer, were 31% of the total polymer, based on the monomers (g-MMA/MM) utilized in relative weight percentage amounts of 71.25 wt % and 28.75 wt %, respectively. In this representation of the dispersants, a double slash indicates a separation between blocks, and a single slash indicates a random copolymer within a block. This and other dispersants were prepared by methods commonly used for ink jet ink dispersants.

The acid groups on the polymer were neutralized with dimethyl ethylamine (DMEA).

Dispersant 2b was an AB block copolymer dispersant having a molecular configuration of:

BMA//MAA 13//10.

### The notation 13//10 indicates 13 monomer units of BMA and 10 monomer units of MM in the block copolymer.

Ti-Pure Titanium Dioxide is commercially available (and was obtained) from E. I. du Pont de Nemours and Company (Wilmington Del.).

### Ink Ex. 1

Ink Ex. 1 was prepared using Slurry Ex. 1 according to the following composition.

TABLE 3
Ink Ex 1

| Ink Ex. 1 | |
|---|---|
| Slurry Ex. 1 | 60.00 |
| DPnP | 40.00 |
| BYK-348 | 0.50 |
| Total | 100.50 |
| % Pigment (Solid) | 24.00 |
| Viscosity (CPS) | 6.79 |
| Surface Tension (Dyne/Cm) | 27.02 |

BYK-348 is a surfactant from Byk Chemie.

This ink was printed on polyvinyl butyral interlayer on a Mamiki JV3 printer and the optical properties are reported in Table 4. The interlayer was used to produce a decorative laminate as described in previously incorporated WO2004018197. The polyvinyl butyral interlayer was printed in a rectangle configuration in multiple passes to test for the % transmission, % haze and % clarity. Each pass was set for printing 100% coverage. After printing, the polyvinyl butyral interlayer was used to make a decorative laminate. A BYK Gardner Hazegard Plus Instrument was used to measure the % T, % H, and % C. Haze (wide angle scattering) is defined as the percentage of transmitted light that in passing through a sample deviates from the incident beam by more than 2.50. Clarity (narrow angle scattering) is measured as scattering at less than 2.50.

TABLE 4
Ink Ex. 1, White Ink Printed Decorative Laminates

| Number of | | | | |
|---|---|---|---|---|
| printing | | | | |
| passes | Glass type | % Transmission | % Haze | % Clarity |
| 1 | Clear | 39.4 | 92.2 | 52.4 |
| 2 | Clear | 29.8 | 97.0 | 40.8 |
| 3 | Clear | 24.7 | 96.2 | 46.9 |
| 4 | Clear | 20.9 | 95.1 | 52.3 |
| 5 | Clear | 19.2 | 89.2 | 66.5 |
| 1 | Starphire | 37.4 | 91.4 | 50.9 |
| 2 | Starphire | 27.7 | 96.9 | 39.4 |
| 3 | Starphire | 22.9 | 95.8 | 45.0 |
| 4 | Starphire | 19.4 | 85.3 | 48.4 |
| 5 | Starphire | 17.3 | 85.8 | 69.8 |

The ‘Clear’ Glass was normal glass made by the float process, and it had a slightly green tint.
The Starphire glass was the PPG “ultra-white” glass

### Test for Whiteness and Yellowness of White Ink Printed Substrates

The polyvinyl butyral decorative laminate used with Ink Ex. 1 was tested for whiteness as measured by ASTM E 313, and yellowness as measured by ASTM D1925. The Whiteness Index was 44.52, and the Yellowness Index was −2.2.

### Ink Ex. 2

Ink Ex. 2 was the ink used in all subsequent color/opacity testing described below and its formulation is given in Table 5.

TABLE 5
Ink Ex. 2

| | Ink Ex. 2 |
|---|---|
| Ti Pure R 700 | 20.0 |
| P-25 Degussa (nano) | 5.0 |
| DPM | 54.6 |
| DPMA | 18.2 |
| Disperbyk ® 2001 | 2.2 |
| Surface Tension | 28.8 |
| Viscosity@ 60 rpm | 5.12 |

P-25 is a nano titanium dioxide from Degussa Corp, Parsipanny NJ.
Ink Ex. 2 was printed on a sheet of polyvinyl butyral (PVB) interlayer using a Mamiki JV3 printer. The white ink was printed alone and in combinations with other colors in two different modes.

Mode 1 (Comparison): The white ink was printed first then the color (CMYK) was printed on the top of it (overprinted)

Mode 2 (Invention): The white ink at 100% coverage was simultaneously printed with the other colors (CMYK).

The printed PVB was laminated according to techniques described in previously incorporated WO2004018197. The Adhesion (PSI) results are summarized in Table 6.

TABLE 6
Laminated Glass Print Properties.

| Color | Alone | Mode 1 | Mode 2 |
|---|---|---|---|
| White (50% coverage) | 2920 | | |
| White (100% coverage) | 2511 | | |
| Cyan | 2285 | 2330 | 2031 |
| Magenta | 2375 | 2024 | 1881 |
| Yellow | 2247 | 2177 | 2039 |
| Black | 2589 | 2400 | 2249 |

The white ink does not adversely affect the adhesion performance of the laminate. Also printing in either of the modes still produced laminates with adhesion tests greater than is 2000 psi. Mode 2 with the simultaneous printing corresponds to the instant invention.

### Ink Ex. 3

Another set of prints were completed with similar ink and printing strategy to Ink Ex. 2. Table 7 shows the laminate adhesion (psi) and color measurements. The white ink/colored ink means the colored ink was printed first followed by the white ink; colored ink/white ink means the white ink was printed first followed by the colored ink; the simultaneous white/colored inks means that the JV3 printed the white and colored inks in essentially a simultaneous random fashion. The green, blue, red and the composite black are combinations of the CMY.

TABLE 7
Adhesion and Color for Ink Ex. 3

| | | |
|---|---|---|
| L | a | b |

White Ink/Colored Ink (Comparison)

| | | | | |
|---|---|---|---|---|
| Black | 2293 | 30.11 | 1.67 | 8.29 |
| Yellow | 1810 | 71.02 | −4.5 | 48.7 |
| Cyan | 2063 | 46.12 | −21.61 | −18.94 |
| Magenta | 1957 | 48.59 | 36.78 | −0.07 |
| Green | 1710 | 45.28 | −28.81 | 8.67 |
| Blue | 1808 | 36.22 | 3.25 | −16.72 |
| Red | 1826 | 48.44 | 31.32 | 21.94 |
| Composite Black | 1747 | 36.41 | −3.92 | 1.32 |

Colored Ink/White Ink (Comparison)

| | | | | |
|---|---|---|---|---|
| Black | 2154 | 28.67 | 0.89 | 6 |
| Yellow | 2094 | 70.7 | −5.27 | 47.22 |
| Cyan | 1984 | 47.87 | −24.67 | −22.36 |
| Magenta | 1764 | 48.44 | 38.4 | −3.78 |
| Green | 1767 | 50.9 | −25.04 | 5.39 |
| Blue | 1813 | 45.76 | 1.53 | −15.17 |
| Red | 1633 | 51.85 | 26.08 | 16.04 |
| Composite Black | 1607 | 47.19 | −4.23 | −1.13 |

Simultaneous White/Colored Ink (Invention)

| | | | | |
|---|---|---|---|---|
| Black | 2456 | 33.42 | 1.26 | 8.05 |
| Yellow | 2246 | 68.89 | −5.01 | 42.86 |
| Cyan | 2237 | 46.97 | −18.64 | −20.11 |
| Magenta | 2033 | 49.07 | 33.94 | −0.35 |
| Green | 1881 | 50.11 | −22.3 | 6 |
| Blue | 2105 | 43.16 | 2.73 | −15.41 |
| Red | 1877 | 51.73 | 22.68 | 15.11 |
| Composite Black | 1909 | 46.3 | −2.76 | 1.51 |

The white ink does not adversely affect the adhesion performance of the laminate. Also printing in the three cases produced laminates with adhesion tests greater than 2000 psi for all but a few of the test squares. The simultaneous white/colored ink corresponds to the instant invention.

### Example of a Utilization of Adobe Photoshop® to Use White as a Process Color

The image that was printed was digitized by means known to those skilled in the art. Instructions to Generate Information to Print the White Process Color
1. Open the digital image in Adobe Photoshop® (version CS was used in this process). The image may be of any multi-channel format that Photoshop will open (TIFF, JPEG, PSD, etc.) and of any multi-channel color designation (CMYK, RGB, L*a*b*, XYZ, etc.).
2. Make an exact copy of the image in a new window.

| | |
|---|---|
| a. Select the whole image | (Ctrl-A) |
| b. Copy that image | (Ctrl-C) |
| c. Create a new image window | (Ctrl-N) |
| d. Paste the image information in the new window | (Ctrl-V) |
| e. Flatten the layer information in the new image | (Layer/Flatten) |

3. Convert new image to Grayscale (Image/Mode/Grayscale)
   a. Discard color information
4. Invert the Image (Ctrl-I)

### Addition of white printing Information to Original Image

| | |
|---|---|
| 1. Open the “Channels” View window | (View/Channels) |
| 2. Create New Channel | (Add New Channel) |

a. Double Click on new channel in “Channels” View

b. Name the Channel (White)

c. “Color Indicates”—Spot Color

d. Define the Color in “Color Picker”

e. Set Solidity to 100%
3. Single Click on “White” Channel
4. Fill image with C,M,Y,K=0%
   a. When the new channel is created, Photoshop automatically fills the channel layer with 100% black. This must be filled with White as to remove all information in the new channel.
5. Copy the Inverted Grayscale image (described in previous section)
6. Paste the information into the “White” channel.
7. Save file in format allowing Spot Channels (PSD, TIFF)

### The use of the of spot color (at 2c) was consist with Photoshop jargon and was not intended to mean spot color as defined earlier.

This methodology was used to print a flower with white petals and green foliage. The artisan was able to control the amount of white by selecting the white channel in the image. From there, the artisan increased the overall coverage of white by using one of many functions (Adjustments/Curves, Saturation, Contrast/Brightness). The overall effect was to increase the digital values across the entire white channel in the digital image. From this increase more white ink was placed in the overall image to increase the overall opacity and other desirable coloring effects.

### Measurement of Color Gamut with White Ink

The printing methodology of the invention was tested to determine gamut comparisons using reflectance measurements. The white ink for this test was similar to Ink Example 2. A color target containing 700 patches was printed using white and without white. The targets were then measured on the Gretag Spectroscan Reflection Spectrophotometer on a black background. As previously the illuminant was D65 and the Observer Angle of 100. The corresponding gamut volumes were then calculated using the GamutVis™ tool that was described in US20040100643 (the disclosure of which is incorporated by reference herein in its entirety for all purposes as if fully set forth).

The data shows that there was an overall increase in the gamut volume of 425% when using white as a process color when measured in the reflectance mode with a black background.

Measurement data was gathered using a Gretag Spectrophotometer with a white background. All other settings were the same as in the gamut test listed above. Table 8 shows the gamut volume data.

TABLE 8
Reflection Color Gamut Volumes (White Background)

| Condition | Volume |
|---|---|
| Without White | 163,940 |
| With White | 81,321 |
| % Difference | 102% |

When the measurement was done with a white background the gamut contracts.

A similar white ink was tested by doing Color Mixture Testing in the Transmission mode for Measurements. A 36 color patch target was produced using both white ink and without white ink. This target was then measured using an X-Rite DTP-41T Series II transmission spectrophotometer. ClE-L*a*b* measurements were taken using D65 illuminant at a 10 degree observer angle. The results are shown in Table 9.

TABLE 9
Transmission Color Gamut Volumes

| Condition | Volume |
|---|---|
| Without White | 141,416 |
| With White | 18,053 |
| % Difference | 870% |

As Table 9 shows, there was a significant decrease in gamut volume when using white ink and measuring the gamut in a transmission mode. This demonstrated the change in opacity caused by the white, shrinking the overall transmission color gamut by a factor of almost 9.

Depending on the mode of observation the white appeared expand gamut in the reflectance mode and contract it in the transmission mode. These observations are key facets of the invention. When viewing an image printed by the instant invention methodology, it appears brighter, more colored. When viewing the image transmission mode, not only was the image still colored, not saturated or masked by an underlying white layer. Furthermore, the person doing the printing can selectively control opacity.

### Demonstration of Opacity

The 36-color patch used above for measuring white ink under transmission conditions was measured for opacity. The data in Table 10 showed an overall increase in optical density (on average) of 185%, with a maximum increase of over 450%. The other point of notice is that for the 100% coverage points, the gain in optical density was somewhat small for the overprints and larger for the primaries (excluding black).

TABLE 10
Opacity Tests

| | % Coverage | No White | White | % Increase |
|---|---|---|---|---|
| Cyan | 25 | 0.1 | 0.57 | 470 |
| Cyan | 50 | 0.11 | 0.6 | 445 |
| Cyan | 75 | 0.14 | 0.66 | 371 |
| Cyan | 100 | 0.22 | 0.74 | 236 |
| Magenta | 25 | 0.11 | 0.62 | 464 |
| Magenta | 50 | 0.14 | 0.7 | 400 |
| Magenta | 75 | 0.2 | 0.79 | 295 |
| Magenta | 100 | 0.31 | 0.86 | 177 |
| Yellow | 25 | 0.19 | 0.7 | 268 |
| Yellow | 50 | 0.34 | 0.87 | 156 |
| Yellow | 75 | 0.55 | 1.03 | 87 |
| Yellow | 100 | 0.85 | 1.13 | 33 |
| Black | 25 | 0.22 | 0.72 | 227 |
| Black | 50 | 0.42 | 0.91 | 117 |
| Black | 75 | 0.68 | 1.12 | 65 |
| Black | 100 | 1.29 | 1.27 | −2 |
| Red | 25 | 0.21 | 0.71 | 238 |
| Red | 50 | 0.37 | 0.86 | 132 |
| Red | 75 | 0.59 | 1.02 | 73 |
| Red | 100 | 0.88 | 1.09 | 24 |
| Green | 25 | 0.19 | 0.71 | 274 |
| Green | 50 | 0.35 | 0.88 | 151 |
| Green | 75 | 0.56 | 0.98 | 75 |
| Green | 100 | 0.81 | 1.02 | 26 |
| Blue | 25 | 0.12 | 0.64 | 433 |
| Blue | 50 | 0.16 | 0.72 | 350 |
| Blue | 75 | 0.24 | 0.79 | 229 |
| Blue | 100 | 0.4 | 0.85 | 113 |
| Black, 3 color | 25 | 0.21 | 0.75 | 257 |
| Black, 3 color | 50 | 0.38 | 0.91 | 139 |
| Black, 3 color | 75 | 0.61 | 0.98 | 61 |
| Black, 3 color | 100 | 0.85 | 0.95 | 12 |
| Black, 4 color | 25 | 0.33 | 0.86 | 161 |
| Black, 4 color | 50 | 0.62 | 1.02 | 65 |
| Black, 4 color | 75 | 0.87 | 0.97 | 11 |
| Black, 4 color | 100 | 1.17 | 1.17 | 0 |

### The average opacity increase was 184% and the maximum increase of 470% was observed for 25% cyan.

### Color Mixture Testing

A 1000 patch color target had 1.00% white mixed into each of the patches. The target was printed and measured both with and without the white ink to determine the change in opacity seen when using white as a process color. Table 11 shows the difference in opacity and the percent increase for the target.

TABLE 11
Opacity Differences for White Mixtures

| | D Opacity | % increase |
|---|---|---|
| Mean | 0.460 | 235.35 |
| Median | 0.51 | 210.53 |
| Maximum | 0.67 | 590.00 |
| Minimum | 0.09 | 110.34 |

White Tone Scale—10 patches, increasing in ink coverage from 10% to 100% in 10% steps, was printed using only white ink from two different preparation batches of Ink Example 2. Table 12 shows the results for both the L*a*b* and Opacity measurements between both batches of white.

TABLE 12
White Tone Scale CIE-L*a*b* Measurements

| | Ink Ex. 2, Batch A | | | Ink Ex. 2, Batch B | | |
|---|---|---|---|---|---|---|
| Ink Coverage, % | L* | a* | b* | L* | a* | B* |
| 10 | 90.85 | 0.01 | 1.85 | 91.28 | −0.12 | 2.08 |
| 20 | 88.58 | 0.22 | 2.73 | 89.24 | 0.11 | 3.06 |
| 30 | 87.18 | 0.42 | 3.45 | 87.8 | 0.24 | 4.07 |
| 40 | 85.57 | 0.51 | 4.42 | 86.03 | 0.63 | 4.96 |
| 50 | 83.49 | 1.01 | 5.02 | 84.33 | 0.91 | 5.56 |
| 60 | 81.66 | 1.19 | 5.53 | 82.35 | 0.99 | 6.6 |
| 70 | 79.65 | 1.36 | 6.26 | 80.42 | 1.36 | 7.27 |
| 80 | 77.91 | 1.54 | 6.93 | 78.23 | 1.63 | 8.02 |
| 90 | 75.1 | 1.62 | 7.78 | 74.92 | 1.93 | 8.73 |
| 100 | 70.9 | 1.49 | 7.79 | 70.66 | 2.04 | 9.02 |

The average dE* between the batches was ˜1.0, showing that there is a very slight difference in ink batches. Table 13 shows the opacity measurements between the two batches.

TABLE 13
White Tone Scale Opacity Measurements

| Ink Coverage, % | Batch A | Batch B |
|---|---|---|
| 10 | 0.12 | 0.12 |
| 20 | 0.16 | 0.15 |
| 30 | 0.18 | 0.18 |
| 40 | 0.21 | 0.21 |
| 50 | 0.24 | 0.24 |
| 60 | 0.27 | 0.27 |
| 70 | 0.31 | 0.31 |
| 80 | 0.34 | 0.35 |
| 90 | 0.39 | 0.40 |
| 100 | 0.45 | 0.48 |

The data shows that was very little difference in the opacities between the two batches.

1. A method for inkjet printing an image onto a clear or translucent substrate, comprising in any workable order:
(1) providing an inkjet printer that is responsive to digital data signals;
(2) loading the printer with a clear or translucent substrate to be printed;
(3) loading the printer with an inkjet ink set comprising a white ink and at least one other colored ink; and
(4) printing onto the substrate using the inkjet ink set in response to the digital data signals to generate the image,
wherein the image has a margin so as to include the at least one other colored ink and the white ink in said image, and wherein the at least one colored ink is not printed onto the substrate outside the margins of the image, and wherein the at least one colored ink and the white ink are printed substantially at the same time.

2. The method of claim 1 where the white ink is printed outside the margin of the image.

3. The method of claim 1 wherein the inkjet printer is a drop-on-demand printer.

4. The method of claim 1 which is an aqueous inkjet ink comprising an aqueous vehicle having dispersed therein:
(a) a titanium dioxide pigment;
(b) a combination of dispersants comprising:
(1) a graft copolymer having a weight average molecular weight of from about 4,000 to about 100,000, comprising from about 90% to about 50% by weight of a polymeric backbone, and from about 10% to about 50% by weight of macromonomer side chains attached to the backbone, the polymeric backbone and macromonomer side chains comprising 100 wt % of the graft copolymer, wherein:
(i) the polymeric backbone is hydrophobic in comparison to the macromonomer side chains and comprises one or more polymerized ethylenically unsaturated hydrophobic monomers and, optionally, up to about 20% by weight, based on the weight of the graft copolymer, of polymerized ethylenically unsaturated acid monomers; and
(ii) each of the macromonomer side chains individually is a hydrophilic polymer containing acids groups attached to the polymeric backbone at a single terminal point, and
(A) has a weight average molecular weight of from about 1,000 to about 30,000, and
(B) comprises from about 2% to about 100% by weight, based on the weight of the macromonomer side chain, of a polymerized ethylenically unsaturated acid monomer, and
(C) wherein the acid groups are at least partially neutralized, preferably with an inorganic base and/or an amine;
(2) a block copolymer of type AB, ABA or ABC wherein at least one of the blocks in the block copolymer is an adsorbing segment, and wherein at least one of the blocks in the block copolymer is a stabilizing segment.

5. The method of claim 3 which further comprises a third dispersant which is a phosphated polymer dispersant comprising a hydrophilic stabilizing segment and a hydrophobic adsorbing segment.

6. The method of claim 1 which is a non-aqueous inkjet ink comprising a non-aqueous liquid carrier having dispersed therein (a) a titanium dioxide pigment and (b) at least one dispersant for the titanium dioxide pigment, wherein:
(i) the non-aqueous liquid carrier comprises an organic solvent or a mixture of organic solvents,
(ii) the organic solvent or mixture of organic solvents has a hydrogen bonding solubility parameter based on Hansen solubility parameters of more than about 9,
(iii) the organic solvent or mixture of organic solvents in non-aqueous liquid carrier comprises are predominantly only non-reactive organic solvents; and
(iv) the conductivity of the ink is from about 1 to about 50 μmho/cm.

7. The method of claim 6 where the solvent mixture has a mixture boiling point of greater than 120° C. at 0.1 kpascals

8. The method of claim 1 where the titanium dioxide consists of pigmentary and nanograde, singly or in combination.

9. The method of claim 6 is used with at least one other colored ink chosen from
a. a yellow ink comprising PY120 dispersed in a non-aqueous vehicle,
b. a magenta ink comprising a complex of PV19 and PR202 dispersed in a non-aqueous vehicle,
c. a cyan ink comprising PB 15:3 and/or PB 15:4 dispersed in a non-aqueous vehicle,
d. a black ink comprising a pigmented black ink.

10. A clear or transparent substrate having a printed image thereon produced by the printing method of claim 1.

11. A safety glass laminate for automotive use having a viewable printed image within produced by the printing method of claim 1.

12. An architectural glass laminate having a viewable printed image within produced by the printing method of claim 1.
